(19) United States
(12) Patent Application Publication
(10) Pub. No.: US 2021/0249032 A1
(43) Pub. Date: Aug. 12, 2021

(54) Processing Audio Information

(71) Applicant: Thinklabs Medical LLC, Centennial, CO (US)

(72) Inventors: Clive Leonard Smith, Centennial, CO (US); Jeremy Schiff, Greenwood Village, CO (US); John Andrew Kreisher, Asheville, NC (US)

(21) Appl. No.: 17/050,938

(22) PCT Filed: Apr. 26, 2019
(86) PCT No.: PCT/US19/29442

§ 371 Date: Oct. 27, 2020

Related U.S. Application Data
(60) Provisional application No. 62/663,487, filed on Apr. 27, 2018.

(51) Int. Cl. G10L 21/14; G10L 21/12; G06F 3/16

(52) U.S. Cl. CPC G10L 21/14; G06F 3/165; G10L 21/12

(57) ABSTRACT

A method for capturing, recording, playing back, visually representing, storing and processing of audio signals, comprises converting the audio signal into a video that pairs the audio with a visual representation of the audio data where such visual representation may contain the waveform, relevant text, spectrogram, wavelet decomposition, or other transformation of the audio data in such a way that the viewer can identify which part of the visual representation is associated with the currently playing audio signal.

### FIELD OF THE INVENTION

The present invention relates to the recording, processing, display, playback and analysis of audio signals.

### BACKGROUND OF THE INVENTION

Most forms of audio playback only allow for one to listen to the audio data and potentially view a waveform of the data as it plays.

Other graphical representations of audio data such as spectrograms exist, but are not in primary use. These representations are displayed similarly to the waveform described above.

Users are usually presented with the option to save their audio data in a file that stores its audible representation. Such formats include mp3, way, and aiff.

Recording of audio signals is typically performed by starting and then halting recording manually.

Machine learning systems for audio signal recognition typically use the one-dimensional audio array as input to an artificial neural network or other adaptive learning system.

Most audio recording technology has someone explicitly start and stop recordings they wish to create.

Such technology usually saves these recordings as just a way or mp3 file that contains only audio data.

Most machine learning systems are trained on images or discrete data sets.

Those that do train based on audio data usually parse characteristics of that data prior to using the data.

### SUMMARY OF THE INVENTION

The present invention is a novel method for capturing, recording, playing back, visually representing, storing and processing of audio signals, generally a recording of cardiac or pulmonic sounds. The invention includes converting the audio signal into a video that pairs the audio with a visual representation of the audio data where such visual representation may contain the waveform, relevant text, spectrogram, wavelet decomposition, or other transformation of the audio data in such a way that the viewer can identify which part of the visual representation is associated with the currently playing audio signal. Such videos are generally in the mp4 format and can be shared with others, saved onto some storage mechanism, or placed onto a hosting site such as You Tube or vimeo and are used especially for research or educational purposes. Visual representations can be used as input for machine learning applications in which the visual representations, mathematically manipulated, provide enhanced performance for pattern recognition of characteristics of the audio signal i.e. a 2- or 3-dimensional version of the audio data enhances the machine learning system's detection accuracy. The invention also includes user interface methods by which the user can retrospectively capture sounds after they have occurred.

The present invention includes a novel method for saving audio data, generally a recording of cardiac or pulmonic sounds in the 16-bit way format, after the user has had a chance to hear and potentially see the recording(s) they would save in a bundle like a zip file that may contain multiple sets of audio data, especially audio data that is associated with a particular position, and also contains information relevant to the recording such as the name of the recorder, text associated with the recording, or the time the recording was made.

The present invention is a novel system for training a machine learning, data regression, or data analysis system from audio data, generally a recording of cardiac or pulmonic sounds in the 16-bit way format, by combining some form of the audio data which may have been filtered, scaled, or otherwise altered with visual representations of the audio such as fourier transformations, wavelet transformations, or waveform displays and textual information.

### BRIEF DESCRIPTION OF THE DRAWINGS

FIG. 1 shows steps to generate video from audio and image;

FIG. 2 shows a display of live (realtime) phonocardiogram or other sound waveform and spectrogram;

FIG. 3 shows audio waveform recordings placed according to stethoscope recording site on the back, typically for lung sounds;

FIG. 4 shows a file system for saving files to a device or cloud storage;

FIG. 5 shows a video generation interactive window providing for video recordings to be tagged and labeled with diagnostic information;

FIG. 6 shows an audio waveform recordings placed according to stethoscope recording site on the chest, typically for heart sounds;

FIG. 7 shows a duplicate of FIG. 2;

FIG. 8 shows a menu for waveform and/or spectrogram annotation with indicator flags (S1, S2, Event of note), action buttons for cropping recording, capturing snapshot or opening notes window;

FIG. 9 shows a notes window which allows for typing of notes and/or tagging recordings with diagnostic information;

FIG. 10 shows: Recorded are displayed and can be played back for immediate listening;

FIG. 11 shows sharing menu which provides ability to share video of sound playback, sharing of recording files as well as notes and screenshots;

FIG. 12 shows save menu facilitating saving files and video to local or cloud storage; and

FIGS. 13A and 13B shows videos generated from waveform image and sounds which can be displayed or previewed as videos in standard video formats playable with video playback apps.

### DETAILED DESCRIPTION OF THE INVENTION

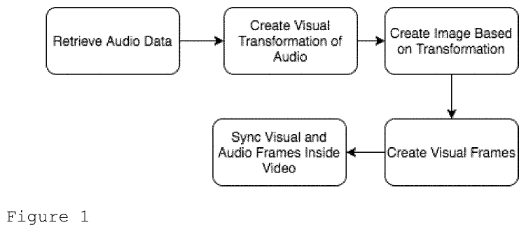

Process Flow for Video Conversion—See FIG. 1.

Video Creation

In the preferred embodiment of the present invention, one has a system consisting of a device with a display, an input device, and recorded audio data somehow accessible by the device, whether in memory, internal storage or external storage. As an example, consider a system with a phone running the Android operating system. In another embodiment, the system may consist of only of a device with the recorded audio data.

The video is created according the following process (as displayed in the above drawing):
1. Retrieve audio data from device. One variant of this is to record incoming audio data from the mic or other audio input source, then store it in device memory. Another variant is to read in an audio or data file from storage.
2. Transform the audio data according to the desired visual transformations. Such transformations may include fourier transformations, wavelet transformations, or time domain waveform displays.
3. Use the transformation in the above step to create one or more visual representations of the audio data. The preferred embodiment of the present invention draws a waveform and a spectrogram consisting of frequency data along a time axis.
4. Take the representation(s) created in step 3 to develop frames for use in the video. Most forms of the present invention will have some sort of indicator on each frame to indicate what part of the audio is currently being played. One method by which this can be done is to have a line on the time axis that correlates with the appropriate audio.
5. Place the developed frames along with the audio data into some sort of video container, possibly an mp4 file, such that the frame is displayed when the audio it is associated with is emitted.

The user of said device may be presented with the ability to configure various aspects of the video, including but not limited to: the visual representations of the audio data to use (for example—waveform, text, spectrogram, wavelet decomposition, etc), the size of the various visual components, the number of times the audio should loop in the video, and/or alterations like filters or volume adjustments to be applied to the audio.

After video creation, some embodiments may allow the user to publish the video onto a hosting site like You Tube, save the video locally, save the video on a cloud storage platform like google drive, view the video, or send the video to another application.

Saving Audio Data

In the preferred embodiment of the present invention, one has a system consisting of a device with a display, an input device, and a way to input audio data. As an example, consider a system with a phone running the Android operating system. In another embodiment, the system may consist of only of a device with a way to input audio data.

The recording is created according the following process:
1. Store any incoming audio data into a buffer. The length of this buffer could be infinite or some arbitrary number set in the process or by user interaction.
2. Using the device input, a user will somehow indicate to the process that he or she wishes to save some time period worth of audio data.
3. Calculate the appropriate number of samples to be taken from the buffer and placed into the recorded data.
4. In some embodiments, the user will be given an opportunity to give the device other information relevant to the recording.
5. Steps 1-4 may be repeated any number of times in any order so long as any given Step 1 precedes its corresponding Step 2.
6. Package all of the information into a single grouping like a zip file.

Machine Learning

In the preferred embodiment of the present invention, one has a system consisting of a machine learning program and a set of audio recordings. The program may be a neural net, a regression, or some other form of data mining or data analysis.

The machine is then trained on a data set constructed via some subset of the following process:
1. Transform the audio data according to the desired visual transformations. Such transformations may include fourier transformations, wavelet transformations, or waveform displays.
2. Use the transformation in the above step to create one or more visual representations of the audio data. The preferred embodiment of the present invention draws a waveform and a spectrogram consisting of frequency data along a time axis.
3. The images of step 2 are then associated with the sounds that created them as well as any sort of other identifying information, especially text, related to said audio data.

In some embodiments of the present invention, one might automatically upload recordings that are saved through some other program or mechanism to be used either immediately or in the future to train the machine learning program.

### DETAILED DESCRIPTION

Visual Representation and Tagging of Audio Signals

The viewing of audio signals on oscilloscopes and computer displays has been commonly done for over a century. The typical display is done by either scrolling the signal representation along a horizontal time axis, or displaying the signal along a horizontal time axis by drawing successive segments of the signal representation from left to right.

Representations of audio signals can take the form of time-domain waveforms; adjusted time-domain waveforms such as compressed or expanded or filtered versions of the time-domain waveforms; spectrograms which are “heat maps” of short time fourier transforms; other spectral or mathematical transformations with are visually represented, such as wavelet transforms; two-dimensional images such as lissajous figures; combinations of representations, either overlaid or stacked, or combinations in multiple windows and a display.

The representations can also be simplified versions of a complex signal. For example, specific segments can be identified with manual or automatic tagging or labeling, or segments can be automatically interpreted to be a specific event in a signal, and simplified to represent the event schematically rather than an actual measurement. A similar process can be performed on a transformed signal such as a fourier or wavelet transform, in which a specific event is represented not only as indicators of actual numerical values, such as a heat map or curve(s), but could be transformed into easy-to-read indicators or graphical symbols or representations.

Specifically, in the present invention, heart sounds could be transformed into time-domain representations of various types. Heart sound comprises a number of segments including the first heart sound and the second heart sound. Between the first heart sound and the second heart sound is called systole. between the second heart sound and the first heart sound is called diastole.

A graphical representation of these heart sounds could comprise a vertical bar for the first heart sound and a vertical bar for the second heart sound the vertical bars being positioned on the time access where the original first and second heart sounds occurred. Alternatively, tags or markers could be placed on the original way form or a representation of the way form indicating where the first heart sound or second heart sound occurred. if there are additional sounds these could be indicated with tags or graphical representations such as vertical bars or other symbols that are meaningful to the viewer.

Another way to modify the time domain waveform could be to compress or expand certain events such as the first heart sound, second heart sound or heart murmurs. They could be additional sounds in the heart sound besides the first and second heart sound such as a food or fourth heart sound or other pathological sounds such as abnormal valves or blood flow. Any one of these abnormal sounds could also be indicated graphically with symbols or bars that are horizontally placed to represent the time of occurrence.

A mathematical transformation of the heart sound could also be done such that the horizontal axis is the time domain and the vertical axis represents another major such as frequency. a third dimension could be added using intensity such as color in a spectrogram we're in the brighter colors indicate higher intensity of a given characteristics such as frequency content. The column app which transforms mathematically transform measurements into quantitative information could be a non-linear color map which enhances certain signal characteristics or heart sounds in a specific way in order to make the representation of the heart sound easier to comprehend by a clinician or lay person. For example, signal energy peaks, bursts of specific frequency ranges, events between first and second heart sounds (systole) or between second and first heart sound (diastole) are enhanced using methods specific to that period of the heart cycle, wherein specific characteristics of the heart sound are enhanced. Such enhancement can change and be customized to the specific cycle of the heart sound.

Another representation or transformation of the original waveform could take the form of a noise reduced version of the original waveform in which the signal amplitude is nevertheless displayed however the display represents a filtered version such that noise or signals that are of interfering nature have been removed.

Lung sounds can be similarly transformed such that characteristics of the breath sound are represented in a graphical or schematic way. Lung sounds can have crackles or other unusual characteristics which indicates fluid inside the lungs or other pathological phenomena. There can also be narrowing of the bronchi or fluid in the lungs and these can produce unusual sounds. The graphical representation of these unusual sounds can also take the form of a frequency or other mathematical transformation or be indicated by symbols or graphical representations that are indirect representations of the events.

Breath sounds can similarly be segmented and selectively filtered during particular phases of the breath cycle, during inhalation and exhalation. During these periods, signal detection can be changed to enhance sudden changes (crackles) or continuous frequency bursts (wheezes) which can occur if the breath sounds have a “musical” quality i.e. tonal bursts rather than the typical white noise characteristics of breath sounds.

Transformation of heart or lung sounds into alternate mathematical representations or noise reduced mathematical representations can be done by selection and control of the operator, or automatically using signal processing techniques, such as adaptive signal processing. Alternatively, machine learning techniques could be used to do pattern recognition and identify pathological phenomena and indicate them graphically or tag them visually.

Bowel sounds with stomach sounds could also be transformed in such a way to enhance specific events or characteristics. Such bowel sounds may be recorded over an extended period of time and the present invention includes the possibility of being able to compress the time domain or segment the time domain in such a way to identify when certain events occur and to remove silent periods.

Signals can be synchronized from beat to beat or breath sound to breath sound, such that periodically repetitive sounds can be overlaid or represented to enhance the periodically occurring sounds. Such overlays of sequentially repetitive cycles of the heart or lungs can be used to filter extraneous sounds while enhancing repetitive sounds. Displaying such characteristics can enhance the display of segments or events of interest in the physiological cycle. The synchronization of sequential sounds is done by detecting repetitive events and using the timing thereof to create the overlaid cumulative results. In some cases, a non-acoustic signal can be used for synchronization, such as ECG or pulse oximetry signal.

For signals that are not repetitive, such as bowel sounds, an interesting way to compress longer recordings and provide useful signals is done by removing periods of a recording which do not include any acoustic events of interest. If the stomach or bowels produce sounds occasionally, the silent periods can be deleted from the recording and the segments of interest stitched together for more rapid review. In such cases, the graphical representation can indicate the deleted portions according to width of separation bars between the actual sounds and/or colors that indicate the amount of time passed. Another method is to show the duration of the silent gaps within the separation bars, so that the reviewer can see the recordings, and the amount of time between recorded segments as a numerical display.

The present invention therefore includes multiple methods of representing audio signals and specifically audio signals of the human body such as heart sounds, lung sounds, carotid sounds, bowel sounds, or other body functions.

The present invention also includes the method of displaying multiple windows of different recordings simultaneously displayed on one screen. These representations could be overlaid one on top of another, or they could be displayed in separate sub windows on a display.

Specifically, the present invention includes a method whereby representations of an audio signal are placed on the display in such a way that they are visually correlated with the anatomical position from which they were captured. This allows a viewer to visually correlate a given recording with anatomical sites for heart sounds, lung sounds, bowel sounds or other anatomical recording sites. The user interface includes the ability to simply touch the anatomical site or touch the recording sub-window or click the anatomical site or recording window with a mouse or other pointer device, and caused that recording to be played back or opened in a new window for further editing and close up viewing. This provides for a very intuitive user experience.

During recording, a user can identify the anatomical sites from which a given recording is being captured, by touching that anatomical site on the device display before or after the recording has been captured thereby by correlating the recording with the anatomical site. Another method for establishing the scar relation, would be an automatic mechanism wherein the movement of the acoustic sensing device is detected automatically and the anatomical position is automatically established via motion sensors, accelerometers, gyroscopes, or other motion or positional sensing means. One alternative method for establishing the anatomical position from which recording is being captured would be to use a still or video image sensor or camera to capture the image of the sensing device on a person's body and automatically identify the position of the device and thereby save the recording correlated to the anatomical position.

Another method of tagging the audio recordings includes the method of capturing the GPS coordinates from a GPS device and storing that information with the recording. This can be extremely valuable in the case of medical or physiological signals, since the GPS coordinates when combined with physiological or pathological information could be used for epidemiological purposes to correlate specific disease outbreaks or pathological phenomena with Geographic locations. Another application would be for the correlation of the recording signal with a given location inside a building such as a hospital or a clinic or correlated with a particular user or patient.

The tagging of a recording can be done with graphical symbols, symbolic representations and also conventional text readable by a viewer. The text can be generated using a touch screen and the operator selecting from a set of predefined tags or identifiers of pathological phenomena including disease acronyms conventionally used in healthcare, or the operator could manually enter natural language text. Alternatively, an analysis algorithm, signal processing method, or machine learning system either locally in a device or remotely located, could automatically identify specific characteristics of a signal and represent those results visually on the display as either tags or text or acronyms or all of the above.

The present invention therefore includes methods by which audio signals can be captured, converted to schematic or mathematically transformed representations, and correlated with the physical characteristics of the origin of the sound such as the anatomical position from which a recording was captured from a person's body. Similarly, if the recordings were related with some other phenomenon, for example the physical position of an acoustic sensor in a geographic location or the physical position of the sensor on an inanimate body such as a vehicle or machine, similar methods of manual or automatic tagging could be performed such that the recordings are tagged and or graphically represented in a way that is correlated with the origin of the sound.

Once the recordings have been captured and processed according to the above methods, or other methods to create a stored file of the audio signals, or a visual representation of the audio signals, regeneration of a video of the sounds and visual representations can be performed.

Regardless of the graphical representation of the audio signal, when a sound is played back, there is typically an indication on the display of the instantaneous position of the current sound being played back. This instantaneous indication may take the form of a vertical line along the horizontal axis that moves such that it indicates the moment or approximate position of the sound being played back, or it can take the form of a pointer that moves across the horizontal time axis in correlation with the sound being reproduced, or the entire signal could be scrolled synchronously across the display in time with the sound being reproduced. the viewer or operator can then listen to the sounds via headphones or loudspeakers, and visually correlate what the operator is hearing with the visual representation of the sound at that moment.

Conversely, visual representations that have been placed on the graphical representation of the signal could also be converted into sounds which are Audible. For example if a tag has been placed at a given location to indicate a specific pathological phenomenon or acoustic phenomenon comment an audio prompt could also be triggered by the loud speakers or headphones to indicate to the user that a specific event of Interest has just been reproduced. The audio prompt could take the form of a short frequency burst such as a beep or a click sound or other sound which is different and stands out from the actual recording that was originally recorded.

A major and novel aspect of the present invention is the generation of a video which combines both the audio signal as the soundtrack with the video representation which is dynamic, such that the video would represent the playback of the signal combined with the correlated video representation. The value of generating a video file of the recording combined with the visual representation, which is dynamic, is that the video thereby reproduced can be played back on any video platform or app or general-purpose platforms for the display and reproduction of the sound-video combination.

Use of Video for Sharing or Storage

Another aspect of the present invention includes the conversion of the visual display described above into a video that is stored or shared or presented as a conventional video file on any platform that is capable of presenting video. The unique value of this capability is these audio recordings, captured by the software in this invention can then be presented on any platform and do not need to be presented or reproduced on apps or customized software platforms designed specifically for audio reproduction.

For example, once the audio captured by the software in the present invention is converted into a video, that video can then be saved to the cloud or a remote storage server; uploaded to general purpose video playback platforms and sharing platforms such as YouTube or Vimeo; shared via social media applications such as Facebook, WhatsApp conventional text messaging apps, secure messaging apps, which allow users to share videos or sounds from one device to another; sent by email; or included in educational presentations such as embedded within a PowerPoint presentation. The videos can also be uploaded to an electronic medical record system installed in a given patient's record to allow for future playback.

The fact that the video is in a general-purpose format means that a user can generate contents in the present invention that can be very widely shared and presented in any form. this is especially useful in medical educational situations, in which an educator may wish to capture unusual patient sounds, and present them to a classroom, or include them in an online version of a research paper or a digital version or online version of a medical textbook.

The use of a video vision of the audio signal, also includes telemedicine applications. A recording of a body sound such as a heart, lung, bowel or vascular sound, along with the video thereof, can be transmitted to a remote medical expert or examiner to be reviewed. The remote examiner would not require any special software other than the ability to display and reproduce video or video with sound on any general-purpose platform.

The steps in this sequence comprise capturing the recording of body sounds from a body sound sensor, converting the recording to a video/audio combination, transmitting that video recording (meaning a video with or without sound) to a remote reviewer, and the remote reviewer then playing back the received video file to diagnose a patient. The same approach can be used for any remote review of an audio sound, from car engines to jet engines to any application in which a sound contains useful information, and a video representation of the sound further enhances the ability to analyze the sound.

A key aspect of the invention is that visual representations of sound are far richer than merely audio representations, and the ability to first represent sounds in a visually interesting way that enhances the sound, and then to present that information as simply as to encode the visual information as a widely used video file, offers the ability to make audio signals and their analysis far more powerful than the sound alone. A key aspect to this is that the visual representation is not merely a waveform, but can take the form of mathematically manipulated versions of the audio that enhance specific signal characteristics. These manipulations can be customized to the particular sound, and to particular segments of the sound.

Machine Learning Use of Images and Video

Another valuable and novel application of the views of a video version of a sound file, is to use that file as input data for a machine learning system or artificial intelligence system. by converting the audio signal into manipulated images that are coupled with the audio signal, specific characteristics of the sound become encoded or represented visually in an image or a sequence of images. This has the potential to provide richer information, or enhance segments of sounds with characteristics of a pathological signal or unusual sound in such a way that an image processing system or machine learning system that processes images and videos could potentially scan the images in place of only the audio signals or in combination with the audio signals, and derive or extract signal characteristics in a unique way.

Such videos could be used initially in the training set for fine-tuning a machine learning system, such as an artificial neural network, or other machine learning system. Later, when an unknown signal needs to be identified automatically by image processing and or machine learning systems that have been trained in this way, the unknown signal can be identified by utilizing video information as input independently, or the video image information along with the audio information could be analyzed by the machine learning system in order to identify the characteristics of interest in the signal.

The present invention therefore includes the capability to utilize a sequence of video images or even a single frame of a video recording as Source data for a machine learning system or in image processing system that is used to extract diagnostic information from the original audio signal. as stated above, the images can be used as the only source of input to the machine learning system, or a sequence of images could be used as the only source of input, or a single or multiple sequence of images could be used in combination with the audio recording itself, as source input to a machine learning system.

The present invention includes the capability to tag the recordings—either audio or video recordings or a combination thereof—Which becomes further input information to a machine learning system. Therefore, the machine learning system can use the image frames, video sequences, audio signals, as well as the information tags and or notes that have been entered by a user, as a rich data set to be used for training the machine learning system or artificial neural network as well as for later analysis of unidentified will partially tagged audio and video input.

One of the key differences between the present invention and the prior art is that in the prior art arrays of audio signal amplitude data, usually 1 dimensional arrays of amplitude versus time, are used as data input to a machine learning system. One of the novel aspects of the present invention is the transformation of the audio signal data into multi-dimensional input data to a machine learning system. For example, the transformation of the audio signal into two dimensions, or three dimensions, provides enhanced data wherein characteristics of the audio signal or patterns in the audio signal are visually enhanced. For example, a particular band of frequency such as low frequencies with high amplitude can be represented as patches of bright color at a particular coordinate location or region on a two-dimensional Cartesian plane. The machine learning system can then be trained to identify patches of bright color or peaks in a contour map or three-dimensional map such that peaks or valleys or patterns of peaks and valleys or images with various color combinations on the Cartesian plane are representative of audio signal characteristics. The machine learning system therefore becomes one of recognizing image patterns or doing image recognition as opposed to merely recognizing audio patterns.

Successive frames of a video provides a time dimension to the sequence of audio signal. So a video representation of an audio signal provides multiple dimensions if one combines the x-axis, the y-axis, the color as a third dimension, as well as sequential frames in which sequential frames can assist the representation of the passing of time or the time axis, it is apparent that a video provides a very rich source of data for a machine learning system. If one adds to that rich set of data the original audio signal or a processed version of the audio signal itself, as well as identifying tags which identify characteristics of the signal such as the pathology or indicators entered by a user to alert the machine learning system to particular occurrences within the audio signal such as an event at a given time, the dataset on which a machine learning system is being trained to recognize patterns in the audio signal becomes extremely rich when compared with the original radio signal that is used for conventional audio signals.

The same enhancements applies to a human analyzing a given sound. In the same way as visual enhancement and video conversion of an audio signal provides enhanced information and enriched information to a machine learning system, the same applies to a human analyzing audio signals using an enriched visual representation and mathematically processed and visualized representation of the original audio signal data. As stated, the conversion of the audio signal that represents a frequency transformation such as a Discrete Fourier transform, a wavelet transformation, any other orthogonal transformation, nonlinear signal processing, time variant signal processing, or any other transformations that converts a sequence of audio signal data into a visual representation or multidimensional representation that can be visualized.

Video Generation

The steps of generating a video file (meaning a video with or without audio) are:

1. Capture the audio recording from an acoustic sensor. The sensor can be a general purpose microphone, the microphone built in the device on which the software is running, an external microphone, a custom acoustic sensor, an electronic stethoscope or body sound sensor, or other sensor means. Such sensor means could even include other parameters such as ECG, pressures or other time-varying measurements of interest, especially physiological measurements or other measurements that are of diagnostic significance for animate or inanimate objects.

2. Storing the sound that has been captured, or retrieving a previously-stored sound or downloading a sound that has been previously captured, or uploading a file to a server or remote device or computer system. This step comprises saving and then retrieving a sound file.

3. Mathematically manipulating the audio signal to produce a visual representation of the audio signal. The mathematical manipulation can be of a general-purpose fixed nature, or it can be a time-invariant or time-variant method that is customized to the particular sound of interest, such as a heart sound, lung sound, bowel sound, vascular sound or other physiological or diagnostic sound. If time-variant, the mathematical manipulation can comprise first segmenting the sound into specific phases such as inhalation and exhalation or phases of the cardiac cycle, or peaks in signal strength of a vascular sound. the invention is not limited to such segmentation and application of customized time-variant mathematical manipulations. The mathematical functions that can be applied include, but are not limited to: digital filtering by frequency, segmenting the sound into sub-bands, non-linear scaling of the signal, transformations into the frequency domain, transformations using orthogonal transforms such as wavelets or other transforms, signal averaging, synchronizing periodic signals to enhance periodic events in the signal, cross and auto correlations. Numerical results can be scaled using linear, non-linear or mathematical functions that enhance the characteristics of the signal. A common approach is to use decibel or logarithmic scales, but the invention includes other non-linear scales including lookup tables that are customized to signals of interest. Such lookup tables can even be time-variant and linked to particular cycles of the sound. Resulting numerical results of this mathematical manipulations can then be represented as one, two three and four-dimensional arrays of values. In most cases, one of the dimensions, explicitly or implied, includes the time axis, correlated to the original recording. Note that there can be two sets of mathematical manipulations. the first can be applied to the sound recording itself, and producing a new sound recording that has been enhanced to improve listening. The second mathematical manipulation can apply to the creation of visual representations. A key aspect of the invention is that the audio and visual manipulations can be different. Filtering and digital effects that enhance sound may be different from those that make a sound visually easy to comprehend. It is a novel aspect of the invention that separate manipulations to enhance and optimize sound and visual representations can be coupled, or independent.

4. Converting the mathematically manipulated results into visual representations. This can include converting numerical values into colors, converting signals into two and three-dimensional images. Usually, a sequence of images or frames are created, each frame correlating to a particular timing of the audio signal recording so that an image is correlated to the time at which a corresponding sound occurred.

5. Converting the sequence of images or frames into a sequence of frames i.e. a moving video, that is usually time-correlated to the original sound, or to a modified version of the sound, but can also be simply a visual representation without sound. The sequence of images shows the progression of sounds over time. This can be represented by a cursor or indicator that scrolls across indicating the moment in time that is being played back on an audio track, or the images can show a scrolling sound file in which the time axis is moving across the screen. Other alternatives include so-called waterfall diagrams which show changes in a signal over time as a three-dimensional image with successive moments being drawn on one of the axes. Alternatively, the visual sequence can be a two-dimensional visual representation that represents sounds changing. For example, in the simplest form, a visual image could pulsate with color in time with a sound, with changing shapes and colors to enhance the listening experience. An example could be listening to a blood pressure signal and the colors change with the intensity of the Korotkoff sounds. This can be helpful to the listener.

6. Encoding the sequence of images, either independently or along with the synchronized audio file, into a video format. This video format can be any format, but is preferably a convenient format for sharing or displaying on numerous platforms such as Youtube, Vimeo, Android phones, iPhones or iOS devices, computers, via social media sharing systems such as Facebook, Twitter, Whatsapp, Snapchat, and similar platforms.

7. Optionally repeating the playback of the recording multiple times, in order to produce a longer video than the duration of the original recording. In this case, the inventive steps include stitching together the repeated sequences such that the video is continuous. This can optionally include fading the sound in and out at the and beginning of the loop segment, so that no audible discontinuity is perceived by the viewer at the point between the end of the loop and the start of the next loop. The determination of the end points can be automatically determined by the software to create a continuous video that has the appearance of a periodic signal. For example, the loop duration could be a multiple of 1X or NX the period of a heartbeat of breath sound, or multiple heartbeats or breath sounds, where N is an integer. This is not a necessary requirement for forming loops, but can improve the perceived continuity of the video.

8. Storage of the file in the local computer or mobile device on which the encoding is being performed. The encoding can take place in a local device, or can be done on a remote server or remote computer that can store the results, or transmit the results.

9. Optionally, transmission of the video file via the internet for remote storage or viewing. This can be done automatically, or the user can select the recipients. For example, a user can instruct the software to generate the video, and then select the communications service to use to send the video, and select the recipients to whom the video is sent. This is a unique and powerful way of sharing sound files along with their video versions, since it affords a user or operator the ability to selectively share the information using general-purpose or custom communications tools, and then allow the recipients to view the results using such general-purpose services or apps.

It should be noted that the present invention includes both real-time generation of videos and generation of videos after recording sounds. Therefore, the methods described herein for mathematically manipulating sounds and images can be done in realtime so that the live listener can view the results at the time of listening or recording the sounds. This is also true for remote listeners, wherein the sounds are transmitted to a remote listener, and the software of the invention generates the visual effects and video in realtime or subsequently, on the remote device. Further, the generation of visual information could be performed by an intermediate computer system to which the sound is uploaded, the video is created in realtime or subsequently, and the resulting video is sent to recipients immediately or later.

User Interface

Conventional audio recording systems typically use a record button and a stop button. The user pushes a key or touches A visual representation of a record key to start recording, and presses a stop key or visual representation of a stop key to stop recording.

While the present invention provides these conventional methods, a novel aspect of the invention is a simple method for retrospectively capturing a signal after it has occurred. This is especially useful in a clinical setting in which an operator may hear a sound of interest such as a heart sound or lung sound and wish to capture the sound that has just been heard.

In the present invention, the audio signal from the sensor is continuously being recorded. The audio signal data is therefore being buffered in a memory, even if the operator has not triggered a recording to commence. If the user then wishes to capture a sound that has occurred, the operator can then provide an input trigger to inform the system to capture the sound and save it from the recording buffer. The input trigger that instructs the software to save the signal can take the form of a physical button push, a touch on a touch screen, a mechanical movements that is sensed by a motion sensing device such as an accelerometer, or a voice instruction such as using the word “keep” or “save” dictated to the system and interpreted automatically by a voice recognition system.

The software then retrieves the previously buffered information and saves it in a format that can be used for audio signal recordings such as .wav .mp3 .aac or other format, or simply raw data or other data structure. The data can then be saved on the device running the software, or uploaded to a remote storage means.

The determination of the amount of time to be saved by retrospective recording means can be determined in a number of ways. The simplest method is for the operator to simply set the number of seconds of recording to be captured from the point that the recording stops backwards in time. For example a typical heart sound might be recorded retrospectively for 5 or 10 seconds. Lung sounds could be recorded for 10 seconds or perhaps 20 seconds. The operator can manually set this desired time.

A second method for determining the amount of time which is retrospectively captured, is for the operator to use a touch screen end pinch-zoom a sub window which is displaying the recorded or real-time data audio signal. As the operator zooms in or out on the recording waveform or image, the time axis is adjusted to show a longer or shorter period of time. The software can use the width of the time window being displayed as the currently selected retrospective recording duration. This is an intuitive and simple way for an operator to control the recording duration on a dynamic basis.

A third method of determining the retrospective recording duration, is for the software to determine via signal analysis and/or machine learning, the amount of time required to capture a high-quality recording of the interesting characteristics of the signal, or sufficient amount of data for an automatic analysis system or machine learning system to analyze the characteristics of the signal with sufficient accuracy. This automatic determination of the amount of time to be captured and saved, can be based on the quality of the signal, the amount of data required for an analysis system, the amount of signal required to adequately display the signals of interest for manual analysis by the operator or analyst, or the recording can be analyzed to ensure that any artifacts or undesired sections of the recording are excluded.

A further method of automatically recording a signal of interest is for the software to analyze the incoming signal in real time or from a buffer recording that was previously captured, in order to determine when a signal of interest is being captured. In the case of a body sound recording sensor such as a stethoscope, the software analyzes the characteristics of the signal such as the frequency contents and or amplitude of the signal, to determine when the sensor has made contact with the live body to commence recording and when the sensor has been removed from the body. The software then analyzes the duration during which the sensor was in contact with the body and records and captures the entire duration of the recording during contact or further trims the recording to reduce the recording to only segments of time during which the recording did not have any undesired artifacts, or reduces the duration of the recording automatically such that it is no longer than the amount of time required for automatic analysis, manual display of characteristics of interest or necessary for other recording, archiving or analytical purposes.

This process of automatically capturing sounds without operator manual intervention as would be the case in the prior art can be combined with methods for automatically determining the location on the live body from which the recording is being captured. Therefore, the software in the present invention can combine automatic determination of duration of recording with the means to detect the position of the sensor on a live body, using a camera or visual means to locate the sensor on a body or accelerometer or motion sensor or even a manual prompt or verbal prompt from the operator. For example, the operator could verbally instruct the software as to the location of a recording, as well as tag the recording with findings or tags which can be used for machine learning, record-keeping, education, or sharing information with a remote colleague for diagnosis. The novelty and benefit of this invention is the ease with which an operator can capture a signal of interest while minimizing the amount of manual control required by the operator to make the recording seamlessly and not interfere with the operator's other tasks.

The convenience of capturing audio signals using all of the above methods, including but not limited to video capture, retrospective capture, conventional recordings, multiple body site recordings and other methods disclosed above, can also be extended to remote methods for doing all of these tasks. The present invention includes the ability to stream sounds, in real-time or near real-time, to a remote mobile device, server, computer or other electronic device such as a smartwatch or other device. The sounds can therefore be streamed via a network such as wifi, bluetooth the internet, cable or other medium, and the same methods can be used to capture and process the audio signal into video, retrospectively capture sounds, save signals, tag data, identify audio signals with a particular body site or recording site on an inanimate object, and other such methods that can be done at the recording location itself. This has benefits for users a few meters away from the recording sensor, or those remotely located, such as in a telemedicine, videoconference or other situation where remote observation or capture is desirable. In such a situation, the remote observer, user or operator can trigger actions to record, to retrospectively capture a sound, to convert sounds to video, save a sound in audio, video or combined formats, tag recordings, identify the position of the sound sensor and add that to a sound record, or any of the other methods described. In cases where the person using the sound sensor is less skilled than the remote listener, there is significant benefit to the remote user being able to perform such tasks. The invention further includes the method of accessing a recording later, from a remote or local computer, and performing the tasks later, to enhance the originally captured audio with additional information. This might be used in a situation in which an audio recording is captured and uploaded, to be examined later, either by manual operator or via automatic means such as a signal analysis system that generates enhanced versions or analyzed versions of the audio signal.

It should be noted that while a primary use of the present invention is for capturing body sounds, the same invention can be applied to other activities in which an audio recording is to be captured easily for recording and/or further analysis, either manual or automatic. The invention is therefore not limited to the specific applications herein described.

Drawings, Diagrams and Screen Images

Screen shots of one software implementation of the present invention are included in the accompanying drawings.

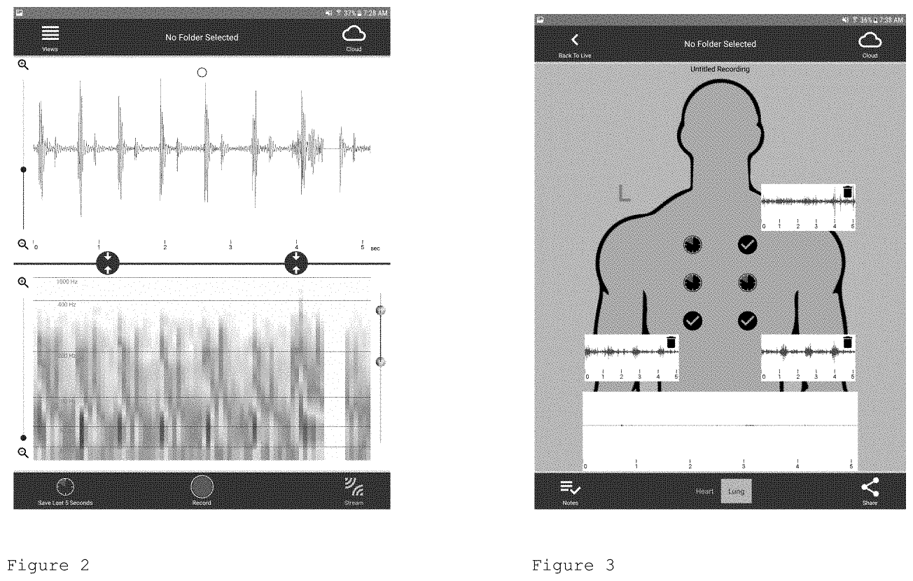

FIG. 2 shows a “live” screen of the audio signal being displayed in real time with the waveform and frequency spectrogram, which could also be a waterfall representation and other display methods of showing frequency and magnitude information, including but not limited to FFT and Wavelet transforms in waterfall, heat map or other display style. The “Save Last 5 Seconds” icon is a unique design element to intuitively show the feature of retrospective recording, showing the “clock style” design with a pie in the counterclockwise direction. This is a unique icon to this design and application. The “Stream” icon is used to launch the live sharing—transmission and reception—of live sounds.

### FIG. 3.

The “Body Image” screen shows a unique aspect of the invention, in that the last N seconds of a recording can be captured with the SAME click/touch of an icon that is located on the body image corresponding to the recording location. So a user, with one click/touch, can both capture a sound AND indicate to the software app where the recording was captured. This is extremely useful in streamlining the use of the device in time-sensitive patient examination environments, in which time is of the essence.

Once the recording is then captured, it is displayed “in situ” on the body diagram, making it even easier to see what has been recorded correlated with the location. Playing and deleting a given recording can also be done with icons that are located ON the body, so that both positional and playback control are implemented with the same icons and touches of the screen.

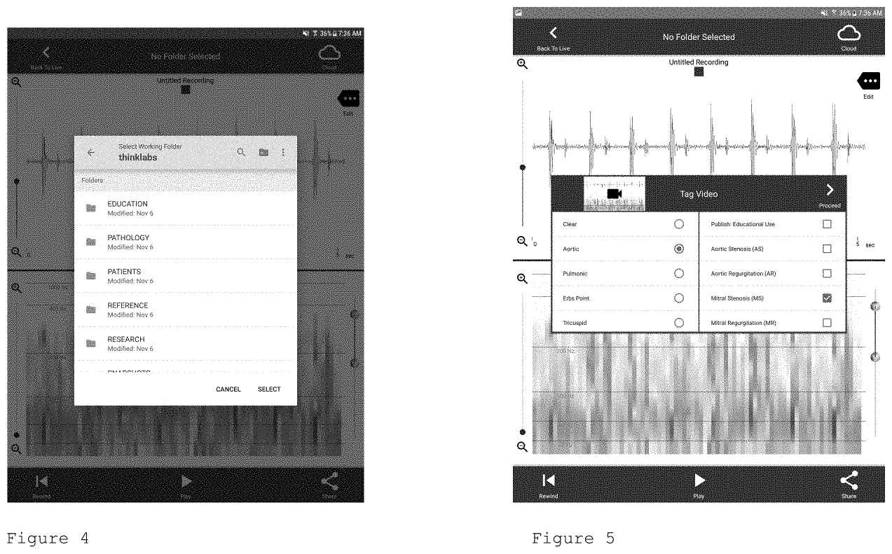

### FIG. 4.

The invention provides for the ability to save files to a cloud storage system, such as Google Drive, Dropbox or other cloud storage. The invention in not limited to one storage system, but allows for the user to SELECT which cloud storage service he/she would like to use.

### FIG. 5

Waveforms, sounds, body image sets, screen shots and videos of the sounds can be tagged with medical information regarding the type of sound, the location of the recording and potential or confirmed diagnoses. This is extremely important for being able to label recordings for education use, machine learning systems, electronic medical records, and other applications. The labels and tags that are captured in this way, are stored with the recording and are also used as labels ON the actual images, videos or other representations of the sound information.

### FIG. 6

The body view shows the single-icon single touch method for capturing recordings and identifying the position on the body at the same time with one touch. The recording is then shown in the position on the body where it was recorded. Below the body is a realtime display of the live waveform, so that the user can see what has just been captured as it occurs, facilitating being able to touch a “record last N seconds” icon to capture what has been recorded. Further, by zooming the realtime window, the user can intuitively change the duration N for capturing. All these methods in the invention contribute to an extraordinary level of intuitive use under time pressure in a clinical setting.

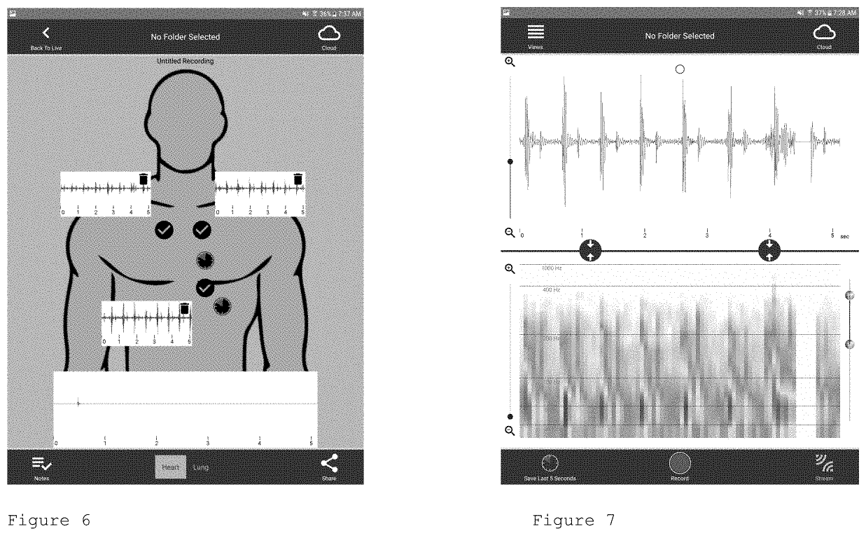

### FIG. 7.

The Record screen or Live screen shows the live waveform and spectral representation of the sound in real time. The user can single-touch the “record last N second” icon (pie chart with partial fill) to capture the last N seconds, the value of N being intuitively set simply by zooming the screen, or it can be set in the Settings of the App.

The Live or Recording screen also shows an icon for establishing a live link between the device and remote systems or devices. By touching the Stream icon, a further menu provides for sending a “pin” or code to remote listeners, or entering a code from a remote transmitter to establish a secure live connection via Bluetooth, Wifi or the Internet.

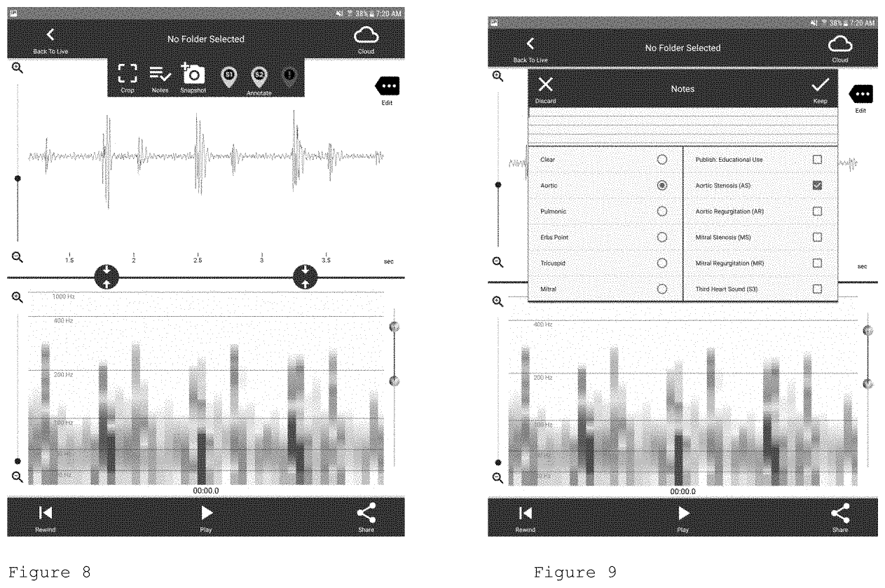

### FIG. 8.

There are further features of the invention to facilitate taking snapshots of the waveforms and/or spectral representations of the sound. These alternate representations are not limited to spectrum but could be any visual representation of the sound. the images can be annotated with markers which are dragged and dropped onto a desired position on the visual representation, making annotation highly intuitive. The user can then add notes, capture an image and thereby enrich the information connected with the sound recording. The information can be separately shared or saved, or the entire set of data can be compressed or encoded into a single file or folder that is stored locally, shared, or uploaded.

The Share icon allows for sharing sound via other apps in the device, such as email, messaging apps, or uploading to websites.

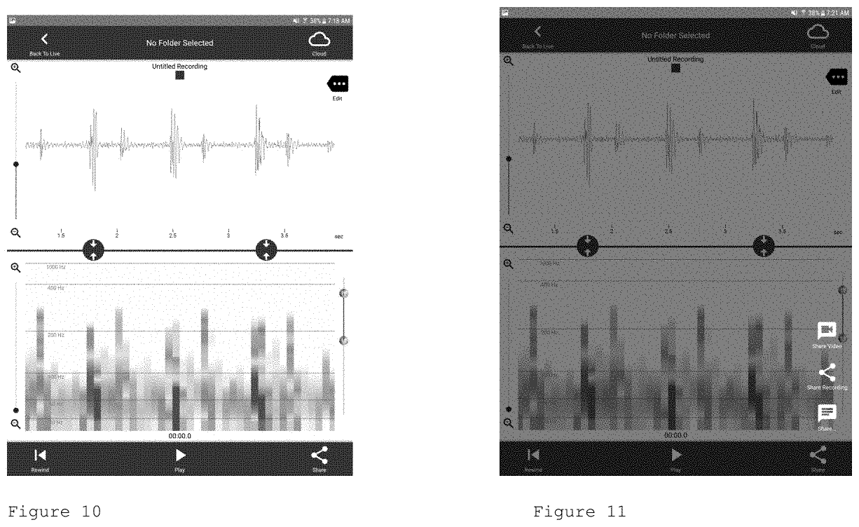

### FIG. 9.

Recordings can be annotated with pathology or other information about the recording, notes, tags, flags and other information, mnemonics or codes, useful for marking images, naming files or coding for machine learning. The ability to use these tags or abbreviations thereof to name files is a useful feature of the app, allowing for quick search of a set of files to locate specific pathologies.

### FIG. 10.

The Playback screen provides for playing back sound on the device. There are also controls for changing the color depth of the spectral image to enhance the spectral image, along with zooming features to zoom into the image and change the scale on the screen.

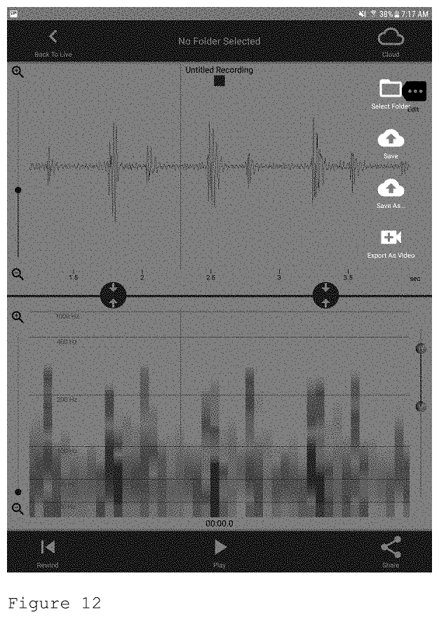

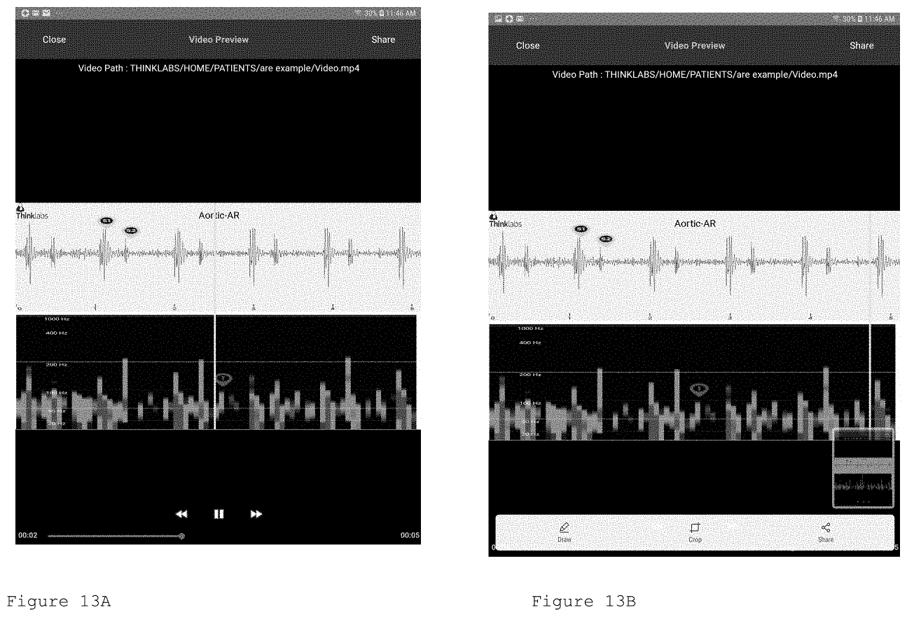

### FIG. 11

Upon touching the Share icon, various options provide for sharing notes, video, recorded sound and so on, with the further option to select the means via which the information is shared, such as email, Whatsapp, Facebook, Twitter, or other sharing platforms, or upload to Youtube, Vimeo and other sites, public or private, encrypted or not.

### FIG. 12.

Recordings, videos, notes and other information can be saved to the cloud, to various online storage services. Specific folders can be selected, and videos can be generated of playback of the sounds. Such video can be generated locally inside the device, or the information can be uploaded to a remote server which does the video processing.

1. A method for capturing, recording, playing back, visually representing, storing and processing of audio signals, comprising converting the audio signal into a video that pairs the audio with a visual representation of the audio data where such visual representation may contain the waveform, relevant text, spectrogram, wavelet decomposition, or other transformation of the audio data in such a way that the viewer can identify which part of the visual representation is associated with the currently playing audio signal.

2. A system for creating a video comprising:
retrieve audio data from a device;
transforming the audio data according to the desired visual transformations which may be selected from one or more of fourier transformations, wavelet transformations, or time domain waveform displays;
using the transformation to create one or more visual representations of the audio data;
taking the representation(s) created to develop frames for use in the video, including an indicator on each frame to indicate what part of the audio is currently being played; and
placing the developed frames along with the audio data into a video container, which may comprise an mp4 file, such that the frame is displayed when the audio it is associated with is emitted.
